(19) United States
(12) Patent Application Publication
(10) Pub. No.: US 2021/0152749 A1
(43) Pub. Date: May 20, 2021

(54) IMAGE PROCESSING APPARATUS, IMAGE PROCESSING METHOD, PROGRAM, AND LEARNING APPARATUS

(71) Applicant: SONY CORPORATION, TOKYO (JP)

(72) Inventors: TEPPEI KURITA, TOKYO (JP); SHUN KAIZU, KANAGAWA (JP)

(21) Appl. No.: 17/046,456

(22) PCT Filed: Jan. 31, 2019
(86) PCT No.: PCT/JP2019/003390

§ 371 Date: Oct. 9, 2020

(30) Foreign Application Priority Data
Apr. 18, 2018 (JP) 2018-079925

(51) Int. Cl. H04N 5/243; G06T 5/50; H04N 5/225; G06T 5/20

(52) U.S. Cl. CPC H04N 5/243; G06T 5/50; H04N 5/2256; G06T 2207/30201; G06T 2207/20081; G06T 2207/20084; G06T 5/20

(57) ABSTRACT

The polarization imaging unit 20 acquires a polarization image of a subject, and outputs the polarization image to the image processing unit 30. An interpolation processing unit 31 of the image processing apparatus 30 performs interpolation processing by using the polarization image acquired by the polarization imaging unit 20 to generate an image signal for each polarization component and each color component. A component image generation unit 32 calculates a specular reflection component and a diffuse reflection component for each pixel and for each color component, and generates, as component images, a specular reflection image representing the specular reflection components and a diffuse reflection image representing the diffuse reflection components. A target image generation unit 33 sets gain for each pixel of the component images by using a learned model on the basis of the component images. Furthermore, the target image generation unit 33 performs level adjustment of the component images for each pixel with the set gain, and generates a target image such as a high-texture image from the level-adjusted component images.

### TECHNICAL FIELD

The present technology relates to an image processing apparatus, an image processing method, a program, and a learning apparatus, and is intended to obtain a target image from a polarization image.

### BACKGROUND ART

Heretofore, there has been proposed performing exposure correction, skin correction, and the like in an imaging apparatus when a face is detected as a subject. For example, Patent Document 1 discloses controlling the correction intensity of a plurality of types of processing to be performed on an image of a human face for making the face look beautiful according to a set facial beauty level.

### CITATION LIST

### Patent Document

Patent Document 1: Japanese Patent Application Laid-Open No. 2010-050602

### SUMMARY OF THE INVENTION

### Problems to be Solved by the Invention

Incidentally, in a case where the correction intensity of each type of correction processing in the processing to be performed on a face image for making the face look beautiful is controlled according to the set facial beauty level, optimal processing cannot be performed on the face image for making the face look beautiful if the facial beauty level is not properly set. Furthermore, there is also a possibility that a correction intensity corresponding to a facial beauty level may not be appropriate even if the facial beauty level is appropriate, depending on imaging conditions and the like. In addition, it is desirable that an image with high texture can be obtained not only for an image of a human face but also for another subject.

Therefore, it is an object of the present technology to provide an image processing apparatus, an image processing method, a program, and a learning apparatus that enable a target image to be easily obtained from a polarization image.

### Solutions to Problems

A first aspect of the present technology is an image processing apparatus including:

a target image generation unit that performs level adjustment of a component image obtained from a polarization image with gain set by use of a learned model on the basis of the component image, and generates a target image from the level-adjusted component image.

In the present technology, level adjustment of a component image obtained from a learning image is performed with gain set for each pixel by use of a learning model such as a deep learning model on the basis of the component image. Then, a learning model that reduces a difference between an evaluation image generated by use of the level-adjusted component image and a target image for the learning image is used as a learned model. Gain is set for each pixel on the basis of a component image obtained from a polarization image by use of the learned model, and a target image such as a high-texture image is generated from the component image subjected to level adjustment with the set gain. The polarization image is an image captured by use of, for example, polarized illumination light.

The component images are, for example, a specular reflection image and a diffuse reflection image. The target image generation unit uses the learned model to set gain for a specular reflection image or gain for a specular reflection image and a diffuse reflection image, and generates a target image on the basis of the diffuse reflection image and the level-adjusted specular reflection image or on the basis of the level-adjusted specular reflection image and the level-adjusted diffuse reflection image. Furthermore, the component image is a polarization component image for each polarization direction. The target image generation unit sets gain for the polarization component image for each polarization direction by using the learned model, and generates a target image on the basis of the level-adjusted polarization component images. In addition, the image processing apparatus may further include a polarization imaging unit that acquires a polarization image.

A second aspect of the present technology is an image processing method including:

causing a target image generation unit to perform level adjustment of a component image obtained from a polarization image with gain set by use of a learned model on the basis of the component image, and generate a target image from the level-adjusted component image.

A third aspect of the present technology is a program for causing a computer to perform image processing by using a polarization image, the program causing the computer to perform:

a step of setting gain by using a learned model on the basis of a component image obtained from a polarization image; a step of performing level adjustment of the component image with the set gain; and a step of generating a target image from the level-adjusted component image.

Note that the program of the present technology is, for example, a program that can be provided to a general-purpose computer capable of executing various program codes, via a storage medium that can provide data in a computer-readable form or a communication medium. That is, the program of the present technology can be provided via, for example, a storage medium such as an optical disk, a magnetic disk, or a semiconductor memory, or a communication medium such as a network. As a result of providing such a program in a computer-readable form, a process corresponding to the program is implemented on a computer.

A fourth aspect of the present technology is a learning apparatus including:

a learned model generation unit that performs level adjustment of a component image obtained from a learning image with gain set by use of a learning model on the basis of the component image, and sets, as a learned model, the learning model that reduces a difference between an evaluation image generated by use of the level-adjusted component image, and a target image.

### Effects of the Invention

According to the present technology, level adjustment of a component image obtained from a polarization image is performed with gain set by use of a learned model on the basis of the component image, and a target image is generated from the level-adjusted component image. Therefore, a target image can be easily obtained from a polarization image. Note that the effects described in the present specification are merely illustrative and not restrictive, and additional effects may also be achieved.

### BRIEF DESCRIPTION OF DRAWINGS

FIG. 1 is a diagram illustrating a configuration of an imaging system.

FIG. 2 is a diagram illustrating a configuration of a polarization imaging unit.

FIG. 3 is a diagram illustrating a pixel configuration of a polarization image acquired by the polarization imaging unit.

FIG. 4 is a diagram illustrating a configuration of an interpolation processing unit.

FIG. 5 is a diagram for describing low-pass filter processing.

FIG. 6 is a diagram showing the relationship between polarization components.

FIG. 7 is a diagram showing polarization images for each polarization component generated for respective color components.

FIG. 8 is a flowchart illustrating the operation of an image processing unit.

FIG. 9 is a diagram showing a configuration of a target image generation unit in a first embodiment.

FIG. 10 is a flowchart showing the operation of the target image generation unit in the first embodiment.

FIG. 11 is a diagram showing an example of the operation of the target image generation unit.

FIG. 12 is a diagram showing a normal image.

FIG. 13 is a diagram showing a configuration of a learning apparatus in the first embodiment.

FIG. 14 is a flowchart showing the operation of the learning apparatus in the first embodiment.

FIG. 15 is a diagram showing a configuration of a target image generation unit in a second embodiment.

FIG. 16 is a flowchart showing the operation of the target image generation unit in the second embodiment.

FIG. 17 is a diagram showing a configuration of a learning apparatus in the second embodiment.

FIG. 18 is a flowchart showing the operation of the learning apparatus in the second embodiment.

FIG. 19 is a diagram showing a configuration of a target image generation unit in a third embodiment.

FIG. 20 is a flowchart showing the operation of the target image generation unit in the third embodiment.

FIG. 21 is a diagram showing a configuration of a learning apparatus in the third embodiment.

FIG. 22 is a flowchart showing the operation of the learning apparatus in the third embodiment.

### MODE FOR CARRYING OUT THE INVENTION

Modes for carrying out the present technology will be described below. In the present technology, learning is performed by use of a component image generated from a group of polarization images acquired by a polarization imaging unit and a group of target images (for example, a group of high-texture images), and an image processing apparatus uses a learned model to generate a target image from a component image. Note that description will be provided in the following order.

1. Regarding Imaging System

2. Regarding Target Image Generation Unit

2-1. First Embodiment of Target Image Generation Unit

2-2. Second Embodiment of Target Image Generation Unit

2-3. Third Embodiment of Target Image Generation Unit

2-4. Fourth Embodiment of Target Image Generation Unit

3. Another Embodiment

4. Application Examples

### 1. Regarding Imaging System

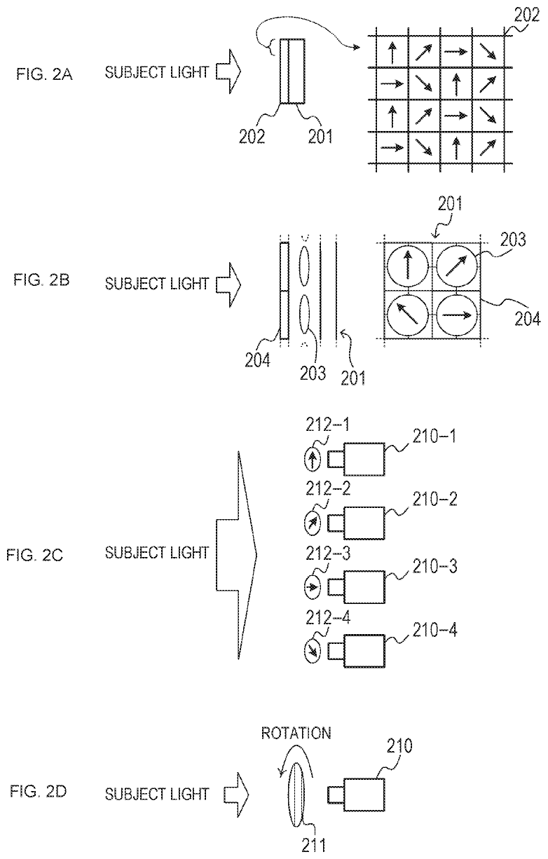

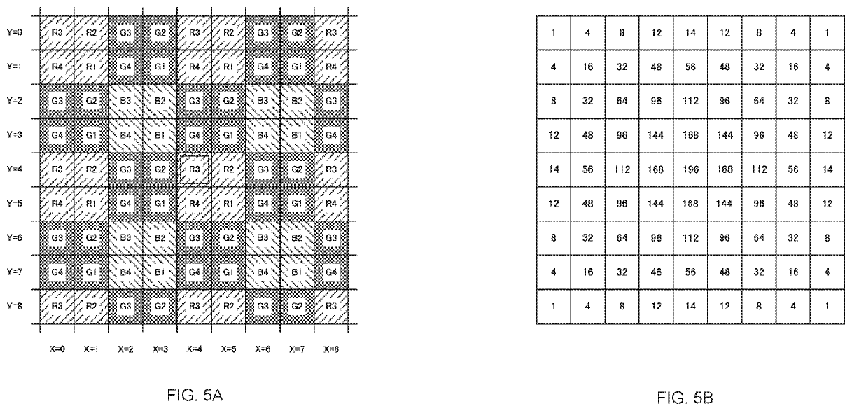

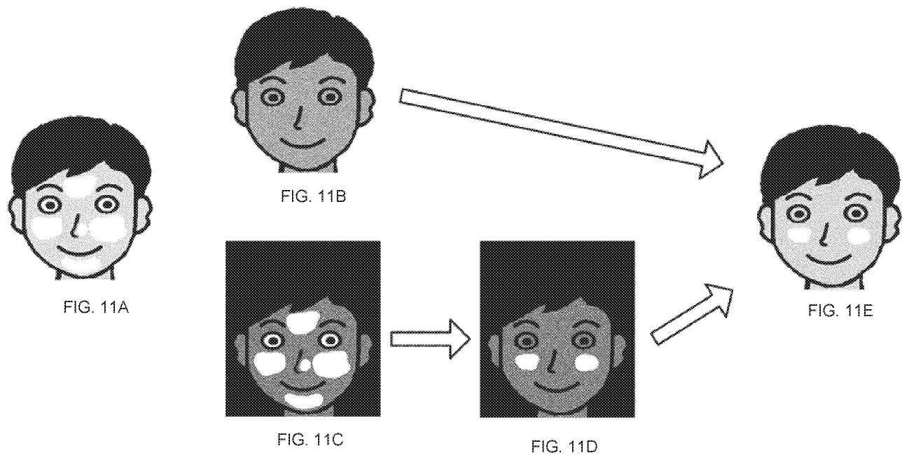

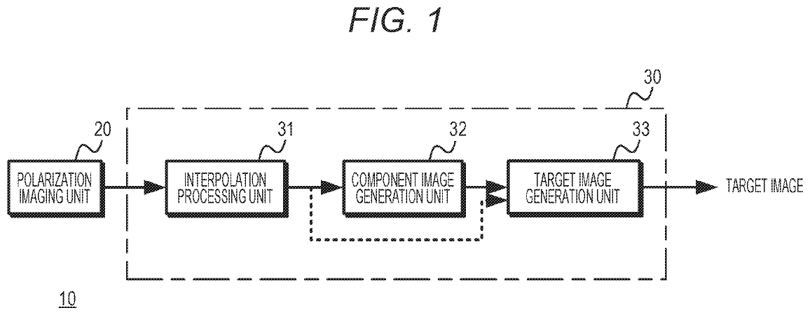

FIG. 1 illustrates a configuration of an imaging system using an image processing apparatus of the present technology. An imaging system 10 includes a polarization imaging unit 20 and an image processing unit 30.

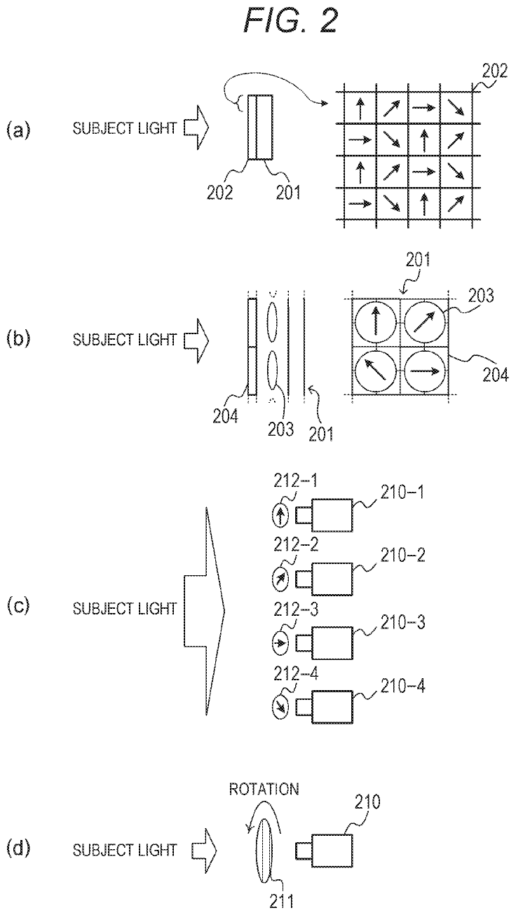

The polarization imaging unit 20 acquires a polarization image of a subject, and outputs the polarization image to the image processing unit 30. FIG. 2 illustrates a configuration of the polarization imaging unit that acquires a polarization image. The polarization imaging unit 20 acquires polarization images of different polarization directions of at least three directions or more (an image with unpolarized light may be included in the polarization images of different polarization directions). For example, as shown in (a) of FIG. 2, the polarization imaging unit 20 includes an image sensor 201 and a polarization filter 202. The image sensor 201 includes a color mosaic filter (not shown) provided on an imaging surface. The polarization filter 202 with a pixel configuration of a plurality of polarization directions is disposed on the image sensor 201. It is possible to acquire a color polarization image with polarization components in a plurality of directions by performing imaging by use of the polarization imaging unit 20 with such a configuration. Note that (a) of FIG. 2 illustrates a case where the polarization filter 202 including pixels, each of which corresponds to any of four different polarization directions (polarization directions are indicated by arrows), is disposed on a front surface of the image sensor 201.

Furthermore, the polarization imaging unit 20 may generate a color polarization image with polarization components in a plurality of directions by using the configuration of a multi-lens array, as shown in (b) of FIG. 2. For example, a plurality of lenses 203 (four in the drawing) is provided on the front surface of the image sensor 201, and an optical image of a subject is formed as an image on the imaging surface of the image sensor 201 by each lens 203. Furthermore, a polarizing plate 204 is provided on the front surface of each lens 203 such that the polarizing plates 204 have different polarization directions. With the polarization imaging unit 20 configured in this way, it is possible to acquire a color polarization image with polarization components in a plurality of directions in a single imaging operation. Furthermore, a plurality of color polarization images with different polarization directions may be generated from a plurality of different viewpoints with a configuration in which polarizing plates 212-1 to 212-4 with polarization directions different from each other are provided in front of imaging units 210-1 to 210-4 as shown in (c) of FIG. 2. In this case, parallax can be ignored in the plurality of color polarization images with different polarization directions if the interval between positions of the lenses 203 or the imaging units 210-1 to 210-4 is sufficiently small to be ignored, as compared to a distance to the subject. Furthermore, in a case where parallax cannot be ignored, color polarization images with different polarization directions are aligned according to the amount of parallax. In addition, in a case where a subject to be recognized moves slowly or in a case where the subject to be recognized operates in a stepwise manner, a polarizing plate 211 may be provided in front of an imaging unit 210, as shown in (d) of FIG. 2. In this case, the polarizing plate 211 is rotated to capture an image in each of a plurality of different polarization directions, so that a plurality of color polarization images with the different polarization directions is obtained.

Furthermore, the polarization imaging unit 20 performs white balance adjustment in a case where a color polarization image is generated. For example, when a white subject is imaged, the polarization imaging unit 20 performs gain adjustment for signals SR, SG, and SB of respective color components so that an image signal indicating the white subject becomes a signal indicating white on the basis of equations (1) to (3). Note that gain Rgain, Ggain, and Bgain are set according to a light source.

SR=Rgain*SR (1)

SG=Ggain*SG (2)

SB=Bgain*SB (3)

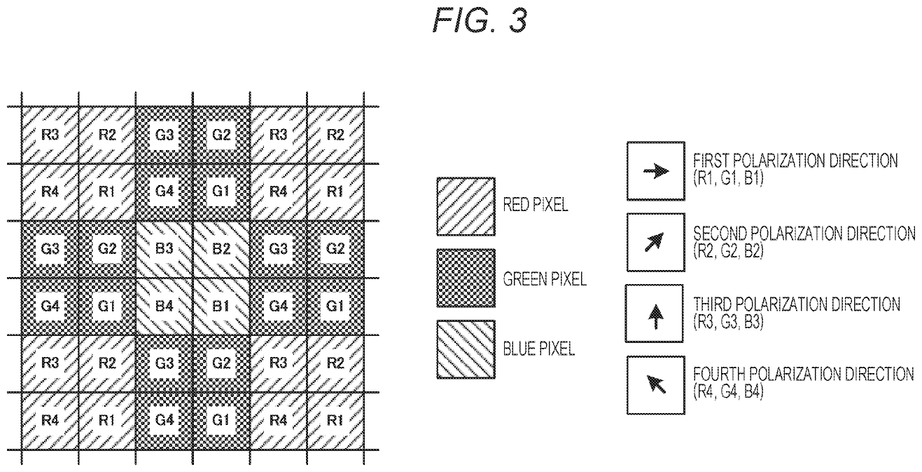

Returning to FIG. 1, in a case where the polarization imaging unit 20 is configured such that a color mosaic filter is provided on the imaging surface of the image sensor, the image processing unit 30 includes an interpolation processing unit 31 that generates a polarization image for each color component. Furthermore, in a case where a polarization filter with a pixel configuration of a plurality of polarization directions is provided on the imaging surface of the image sensor as shown in (a) of FIG. 2, the interpolation processing unit 31 generates a polarization image for each color component and each polarization direction. Described below is interpolation processing of a polarization image acquired by the polarization imaging unit in which the color mosaic filter and the polarization filter with a pixel configuration of a plurality of polarization directions are provided on the imaging surface of the image sensor. FIG. 3 illustrates a pixel configuration of a polarization image acquired by the polarization imaging unit, in which a pixel R1 is a red pixel in a first polarization direction, a pixel R2 is a red pixel in a second polarization direction, a pixel R3 is a red pixel in a third polarization direction, and a pixel R4 is a red pixel in a fourth polarization direction. Similarly, FIG. 3 shows that a pixel G1 is a green pixel in the first polarization direction, a pixel G2 is a green pixel in the second polarization direction, a pixel G3 is a green pixel in the third polarization direction, and a pixel G4 is a green pixel in the fourth polarization direction. Furthermore, FIG. 3 shows that a pixel B1 is a blue pixel in the first polarization direction, a pixel B2 is a blue pixel in the second polarization direction, a pixel B3 is a blue pixel in the third polarization direction, and a pixel B4 is a blue pixel in the fourth polarization direction.

The interpolation processing unit 31 performs interpolation processing by using an image signal of a color polarization image including a pixel for each of a plurality of polarization components generated by the polarization imaging unit 20, and generates an image signal for each polarization component and each color component. In the interpolation processing, a pixel signal is generated for each polarization component and each color component in a target pixel by use of, for each color component, a pixel signal of the target pixel of a polarization image and a pixel signal of a pixel for each of the same polarization components, located in the vicinity of the target pixel.

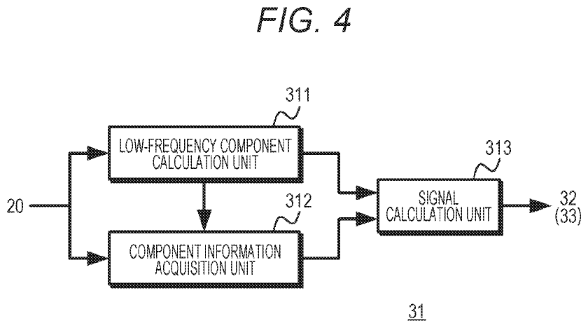

FIG. 4 illustrates a configuration of the interpolation processing unit. The interpolation processing unit 31 includes a low-frequency component calculation unit 311, a component information acquisition unit 312, and a signal calculation unit 313.

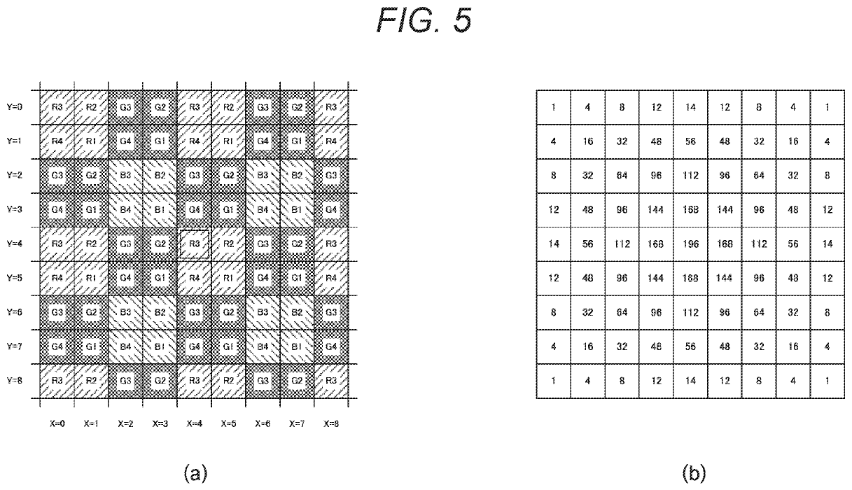

The low-frequency component calculation unit 311 calculates, for each color component, a low-frequency component for each polarization component by using a pixel signal of a pixel located in the vicinity of a target pixel in a color polarization image generated by the polarization imaging unit 20, for each color component and each of the same polarization components. The low-frequency component calculation unit 311 calculates, for each color component, a low-frequency component for each polarization component by performing a two-dimensional filtering process by using, for each color component, a pixel signal of a pixel of the same polarization component, located in the vicinity of the target pixel for each polarization component. FIG. 5 is a diagram for describing low-pass filter processing. The low-frequency component calculation unit 311 calculates a low-frequency component by using, for example, a two-dimensional weighted filter. Here, (a) of FIG. 5 illustrates pixels to be used in the two-dimensional filter, and (b) of FIG. 5 illustrates filter coefficients. The low-frequency component calculation unit 311 calculates, for each color component, a low-frequency component for each polarization component in a target pixel indicated by a double-lined frame by using, for example, a two-dimensional filter with 9×9 taps. Note that (a) of FIG. 5 illustrates a case where the target pixel is a pixel of an R3 polarization component.

In a case where a low-frequency component for each polarization component is calculated for each color component, the low-frequency component calculation unit 311 calculates, for each color component, a low-frequency component for each polarization component in the target pixel by using pixel signals of pixels of the same polarization component and color component in the 9×9 taps and filter coefficients corresponding to the pixels. Specifically, for each polarization component, the signals of pixels of the same color component and polarization component are multiplied by filter coefficients corresponding to the pixels, and the weighted sum of multiplication results is divided by the sum of the weights to calculate a low-frequency component.

In a case where the target pixel (x=4, y=4) is the R3 polarization component as shown in (a) of FIG. 5, the low-frequency component calculation unit 311 uses equation (4) to calculate a low-frequency component R3LPF of the R3 polarization component. Note that in the equation shown below, SRn(x, y) denotes the pixel signal of an Rn polarization component at coordinates (x, y), SGn(x, y) denotes the pixel signal of a Gn polarization component at the coordinates (x, y), and SBn(x, y) denotes the pixel signal of a Bn polarization component at the coordinates (x, y).

SR3LPF=(1*SR3(0,0)+14*SR3(4,0)+1*SR3(8,0)+14*SR3(0,4)+196*SR3(4,4)+14*SR3(8,4)+1*SR3(0,8)+14*SR3(4,8)+1*SR3(8,8))/256 (4)

The low-frequency component calculation unit 311 calculates not only the low-frequency component SR3LPF of the R3 polarization component in the target pixel, but also a low-frequency component SR1LPF of an R1 polarization component in the target pixel by using equation (5). Moreover, the low-frequency component calculation unit 311 calculates a low-frequency component SR2LPF of an R2 polarization component in the target pixel by using equation (6), and calculates a low-frequency component SR4LPF of an R4 polarization component in the target pixel by using equation (7).

SR1LPF=(16*SR1(1,1)+48*SR1(5,1)+48*SR1(1,5)+144*SR1(5,5))/256 (5)

SR2LPF=(4*SR2(1,0)+12*SR2(5,0)+56*SR2(1,4)+168*SR2(5,4)+4*SR2(1,8)+12*SR2(5,8))/256 (6)

SR4LPF=(4*SR4(0,1)+56*SR4(4,1)+4*SR4(8,1)+12*SR4(0,5)+168*SR4(4,5)+12*SR4(8,5))/256 (7)

Furthermore, the low-frequency component calculation unit 311 calculates a low-frequency component for each polarization component not only for the red component but also for the green component and the blue component in the target pixel. For example, a low-frequency component SG3LPF of a G3 polarization component in the target pixel is calculated by use of equation (8), and a low-frequency component SB3LPF of a B3 polarization component in the target pixel is calculated by use of equation (9). Furthermore, the low-frequency component calculation unit 311 also calculates low-frequency components for the other polarization components of the green component and the blue component in a similar manner.

SG3LPF=(8*SG3(2,0)+8*SG3(6,0)+8*SG3(0,2)+112*SG3(4,2)+8*SG3(8,2)+112*SG3(2,4)+112*SG3(6,4)+8*SG3(0,6)+112*SG3(4,6)+8*SG3(8,6)+8*SG3(2,8)+8*SG3(6,8))/512 (8)

SB3LPF=(64*SB3(2,2)+64*SB3(6,2)+64*SB3(2,6)+64*SB3(6,6))/256 (9)

The low-frequency component calculation unit 311 performs the above-described processing by using, as a target pixel, each pixel in a polarization image generated by the polarization imaging unit 20, and calculates the low-frequency components SR1LPF to SR4LPF, SG1LPF to SG4LPF, and SB1LPF to SB4LPF for each pixel. The low-frequency component calculation unit 311 outputs the calculated low-frequency components to the component information acquisition unit 312 and the signal calculation unit 313.

The component information acquisition unit 312 acquires component information indicating the relationship between the low-frequency component of the polarization component of the polarization image calculated by the low-frequency component calculation unit 311 for the target pixel in the polarization image and the pixel signal of the target pixel. For example, the component information acquisition unit 312 sets, as the component information, high-frequency addition gain in which a pixel signal of the target pixel is obtained as a result of adding a high-frequency component to the low-frequency component of the target pixel. In a case where the target pixel is, for example, a pixel with coordinates (4, 4) shown in (a) of FIG. 5, the component information acquisition unit 312 calculates high-frequency addition gain SDhpg by using equation (10).

SDhpg=SR3(4,4)/SR3LPF (10)

Similarly, in a case where the target pixel is a pixel with coordinates (3, 4), the component information acquisition unit 312 calculates the high-frequency addition gain SDhpg by using equation (11).

SDhpg=SG2(3,4)/SG2LPF (11)

The component information acquisition unit 312 calculates the high-frequency addition gain SDhpg at each pixel position by using, as a target pixel, each pixel in the color polarization image generated by the polarization imaging unit 20, and outputs the calculated high-frequency addition gain SDhpg to the signal calculation unit 313.

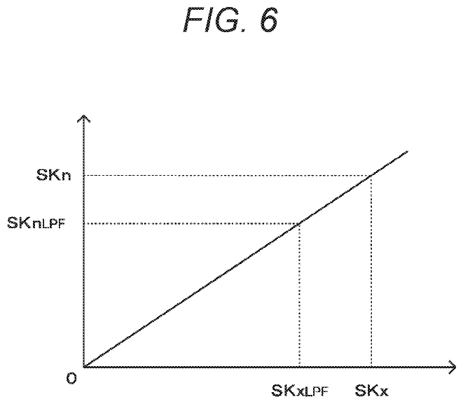

The signal calculation unit 313 calculates, for each color component, a pixel signal for each polarization component in the target pixel on the basis of the low-frequency component calculated by the low-frequency component calculation unit 311 for each polarization component and each color component, and the component information acquired by the component information acquisition unit 312. The signal calculation unit 313 applies the relationship between the low-frequency component of the polarization component of the polarization image in the target pixel and the pixel signal to the relationship between the low-frequency component of another polarization component in the target pixel and the pixel signal of the another polarization component. That is, the signal calculation unit 313 calculates, for each color component, a pixel signal for each polarization component in the target pixel from the high-frequency addition gain of the target pixel calculated by the component information acquisition unit 312 and the low-frequency component of each polarization component of the target pixel calculated by the low-frequency component calculation unit 311. FIG. 6 shows the relationship between polarization components. The signal calculation unit 313 applies the relationship between a pixel signal SKx and a low-frequency component SKxLPF of the target pixel in the polarization image to the relationship between a pixel signal SKn (n≠x) and a low-frequency component SKnLPF of another polarization component in the target pixel, and calculates the pixel signal SKn. Note that K denotes a color channel (R, G, B), and n denotes a polarization direction.

The signal calculation unit 313 calculates a pixel signal SRn (SGn, SBn) from the high-frequency addition gain SDhpg and a low-frequency component SRnLPF (SGnLPF, SBnLPF) on the basis of equations (12) to (14).

SRn=SRnLPF*SDhpg (12)

SGn=SGnLPF*SDhpg (13)

SBn=SBnLPF*SDhpg (14)

For example, in a case where the target pixel has coordinates (4, 4) in (a) of FIG. 5, the signal calculation unit 313 calculates a pixel signal SG2 of a G2 polarization component of the target pixel on the basis of equation (15).

$$SG 2 = SG 2 LPF * SDhpg = SG 2 LPF * ( SR 3 ( 4 , 4 ) \text{/} SR 3 LPF ) = ( 12 * G 2 ( 3 , 0 ) + 4 * G 2 ( 7 , 0 ) + 32 * G 2 ( 1 , 2 ) + 96 * G 2 ( 5 , 2 ) + 168 * G 2 ( 3 , 4 ) + 56 * G 2 ( 7 , 4 ) + 32 * G 2 ( 1 , 6 ) + 96 * G 2 ( 5 , 6 ) + 12 * G 2 ( 3 , 8 ) + 4 * G 2 ( 7 , 8 ) ) \text{/} 512 * R 3 ( 2 , 2 ) \text{/} ( 1 * R 3 ( 0 , 0 ) + 14 * R 3 ( 4 , 0 ) + 1 * R 3 ( 8 , 0 ) + 14 * R 3 ( 0 , 4 ) + 196 * R 3 ( 4 , 4 ) + 14 * R 3 ( 8 , 4 ) + 1 * R 3 ( 0 , 8 ) + 14 * R 3 ( 4 , 8 ) + 1 * R 3 ( 8 , 8 ) ) * 256 \qquad ( 15 )$$

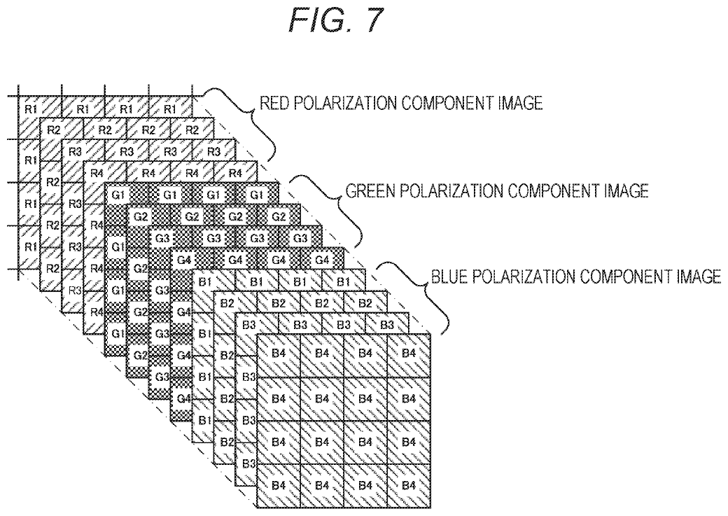

Furthermore, the signal calculation unit 313 performs similar processing by using, as a target pixel, each pixel in the color polarization image generated by the polarization imaging unit 20 to generate, for each color component, a polarization image for each polarization component, and outputs the generated polarization images to a reflection component image generation unit 32. FIG. 7 is a diagram showing polarization images for each polarization component generated for respective color components.

Note that the polarization image generated by the interpolation processing unit 31 is not limited to a polarization image for each polarization component and each color component with a resolution equal to that of the color polarization image generated by the polarization imaging unit 20 as described above. For example, only the red pixels (blue pixels) shown in (a) of FIG. 5 may be used to generate a polarization image representing the red component (blue component) for each polarization component from a polarization image in which resolutions in the horizontal and vertical directions are ½ and each pixel is in any of the polarization directions. In this case, it is possible to generate, for a green pixel, a polarization image representing the green component for each polarization component with a resolution of ½ by using adjacent pixels located on the right and left of a red pixel or adjacent pixels located on the right and left of a blue pixel. Furthermore, in a case where the polarization imaging unit 20 has the configuration shown in (c) or (d) of FIG. 2, it is possible to generate a polarization image for each polarization direction and each color component by performing interpolation processing similar to the conventional interpolation processing for each polarization direction. This is because a color image is acquired for each polarization direction.

Returning to FIG. 1, the image processing unit 30 includes the component image generation unit 32. The component image generation unit 32 calculates a specular reflection component Rs and a diffuse reflection component Rd for each pixel and each color component. The reflection component image generation unit 32 calculates a specular reflection component Rsk on the basis of, for example, equation (16). Note that “k” denotes the color channel (R, G, B) in equation (16) and equations (17) to (20) to be described later. In addition, the reflection component image generation unit 32 calculates a diffuse reflection component Rdk on the basis of, for example, equation (17). In equations (16) and (17), variables ak, bk, and ck are calculated on the basis of equations (18) to (20). The component image generation unit 32 outputs, as component images, a specular image representing the calculated specular reflection component Rs and a diffuse reflection image representing the calculated diffuse reflection component Rd to a target image generation unit 33.

$$[ Math . 1 ]$$

$$\begin{matrix}{s}^{k} = \sqrt{{a}^{k} + {b}^{k}} & ( 16 ) \\ {d}^{k} = {c}^{k} - {s}^{k} & ( 17 ) \\ {a}^{k} = \frac{{I}_{45}^{k} - {I}_{135}^{k}}{2} & ( 18 ) \\ {b}^{k} = \frac{{I}_{0}^{k} - {I}_{90}^{k}}{2} & ( 19 ) \\ {c}^{k} = \frac{{I}_{0}^{k} + {I}_{45}^{k} + {I}_{90}^{k} + {I}_{135}^{k}}{4} & ( 20 )\end{matrix}$$

The target image generation unit 33 sets the gain of component images for each pixel by using a learned model on the basis of the component images. In addition, the target image generation unit 33 performs level adjustment of the component images with the set gain, and generates a target image from the level-adjusted component images. The target image generation unit 33 uses, as component images, the specular reflection image and the diffuse reflection image generated by the component image generation unit 32. Furthermore, the target image generation unit 33 may use, as a component image, a polarization image generated by the interpolation processing unit 31 for each polarization direction.

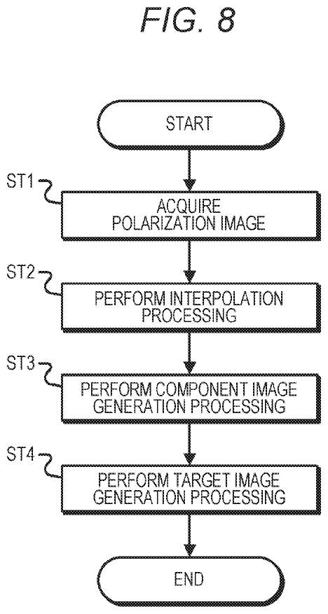

FIG. 8 is a flowchart illustrating the operation of the image processing unit. In step ST1, the image processing unit acquires a polarization image. The image processing unit 30 acquires a polarization image generated by the polarization imaging unit 20, and proceeds to step ST2.

In step ST2, the image processing unit performs interpolation processing. The interpolation processing unit 31 of the image processing unit 30 performs demosaic processing by using the polarization image acquired in step ST1 to generate a polarization image for each polarization direction and each color component, and proceeds to step ST3.

In step ST3, the image processing unit performs component image generation processing. The component image generation unit 32 of the image processing unit 30 generates, for example, a specular reflection image and a diffuse reflection image on the basis of the polarization image for each polarization direction and each color component, and proceeds to step ST4.

In step ST4, the image processing unit performs target image generation processing. The target image generation unit 33 of the image processing unit 30 performs level adjustment of the component images generated in step ST3 with gain set by use of a learned model on the basis of the component images, and generates a target image from the level-adjusted component images. Note that in a case where a polarization image for each polarization direction is used as a component image, the image processing unit does not need to perform the processing of step ST3.

### 2. Regarding Target Image Generation Unit

Next, details of the target image generation unit 33 will be described. Note that in the following description, for example, a high-texture image is generated as a target image.

<2-1. First Embodiment of Target Image Generation Unit>

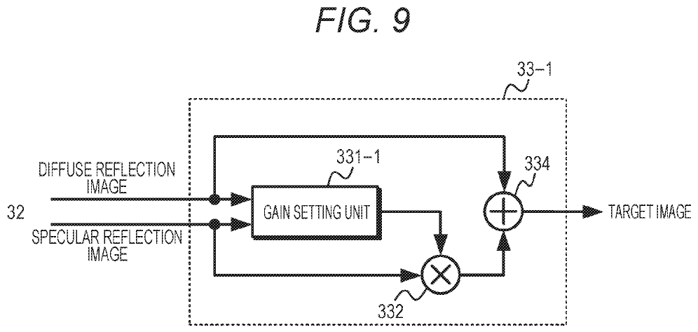

FIG. 9 shows a configuration of a target image generation unit in a first embodiment. A target image generation unit 33-1 includes a gain setting unit 331, a multiplication unit 332, and an addition unit 334.

A specular reflection image representing a specular reflection component calculated by the component image generation unit 32 is output to the gain setting unit 331 and the multiplication unit 332, and a diffuse reflection image representing a diffuse reflection component is output to the gain setting unit 331 and the addition unit 334.

The gain setting unit 331 sets, for each pixel, gain for the specular reflection image on the basis of the specular reflection image and the diffuse reflection image by using a learned model, and outputs the gain to the multiplication unit 332. Note that details of the learned model will be described later.

The multiplication unit 332 multiplies the image signal of the specular reflection image by the gain set by the gain setting unit 331 to perform level adjustment of the specular reflection image, and outputs the level-adjusted specular reflection image to the addition unit 334.

The addition unit 334 adds the specular reflection image and the level-adjusted specular reflection image supplied from the multiplication unit 332 to generate a high-texture image.

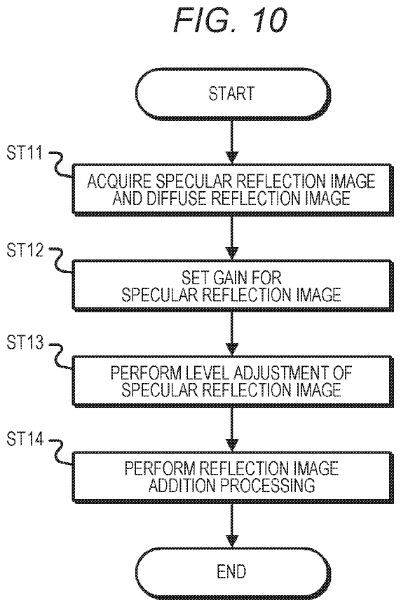

FIG. 10 is a flowchart showing the operation of the target image generation unit in the first embodiment. In step ST11, the target image generation unit acquires a specular reflection image and a diffuse reflection image. The target image generation unit 33 acquires a specular reflection image representing a specular reflection component calculated by the component image generation unit 32 and a specular reflection image representing a diffuse reflection component, and proceeds to step ST12.

In step ST12, the target image generation unit sets gain for the specular reflection image. The target image generation unit 33-1 sets gain for each pixel of the specular reflection image by using a preset learned model on the basis of the specular reflection image and the diffuse reflection image, and proceeds to step ST13.

In step ST13, the target image generation unit performs level adjustment of the specular reflection image. The target image generation unit 33-1 performs level adjustment of the specular reflection image with the gain set in step ST12, and proceeds to step ST14.

In step ST14, the target image generation unit performs reflection image addition processing. The target image generation unit 33-1 adds the diffuse reflection image acquired in step ST11 and the specular reflection image subjected to the level adjustment in step ST13 to generate a high-texture image.

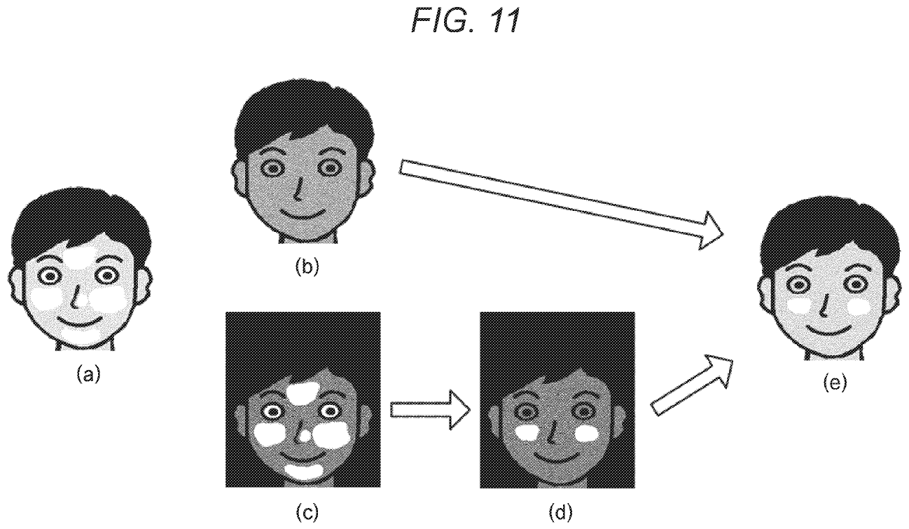

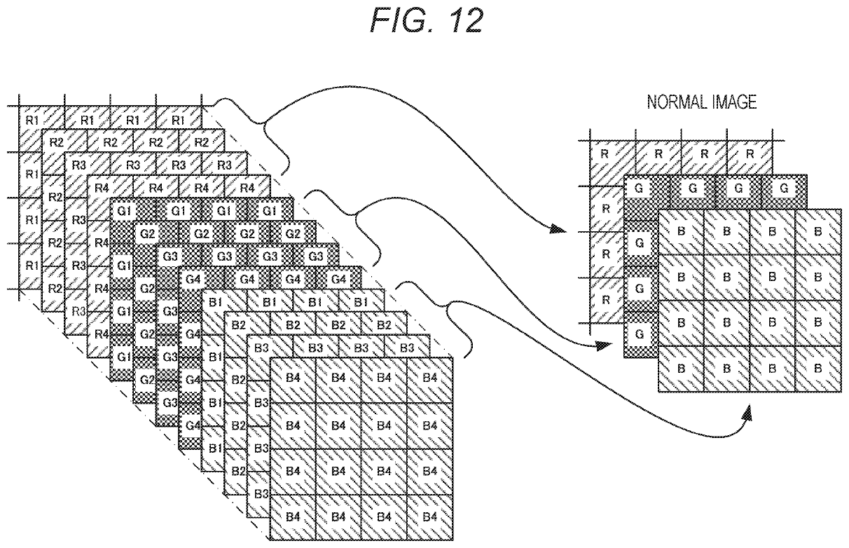

FIG. 11 shows an example of the operation of the target image generation unit. Here, (a) of FIG. 11 illustrates a normal image based on a polarization image acquired by the polarization imaging unit 20. Note that the normal image based on a polarization image, as shown in FIG. 12, is an image representing an average value in all polarization directions for each color component at each pixel position, and pixel signals SRm, SGm, and SBm of each pixel of the normal image can be calculated on the basis of equations (21) to (23).

SRm=(SR1+SR2+SR3+SR4)/4 (21)

SGm=(SG1+SG2+SG3+SG4)/4 (22)

SBm=(SB1+SB2+SB3+SB4)/4 (23)

Here, (b) of FIG. 11 shows a diffuse reflection image based on a polarization image acquired by the polarization imaging unit 20, and (c) of FIG. 11 shows a specular reflection image based on the polarization image acquired by the polarization imaging unit 20. A gain setting unit 331-1 of the target image generation unit 33-1 performs level adjustment of the specular reflection image with the gain set by use of a learned model on the basis of the specular reflection image and the diffuse reflection image. Note that the learned model is generated by use of a high-texture image processed in such a way as to, for example, reduce the shine of an entire face and eliminate the shine in the forehead and the lower jaw. Therefore, the specular reflection image shown in (c) of FIG. 11 turns to, for example, a specular reflection image shown in (d) of FIG. 11 after the level adjustment. As a result of adding the level-adjusted specular reflection image and the diffuse reflection image, it is possible to, for example, reduce unnecessary shine shown in the normal image and generate a high-texture image with no shine in the forehead and the lower jaw, as shown in (e) of FIG. 11.

Next, a learning apparatus that generates a learned model will be described. A learning apparatus 50-1 performs machine learning by using a group of learning images acquired by use of the polarization imaging unit 20 and a desired target image corresponding to each image of the group of learning images to generate a learned model.

The target image to be used for learning is a high-texture image generated as a result of performing desired processing on a learning image, such as a high-texture image with a preferable texture in terms of a beautiful face or the like. A retoucher may generate a target image, and cloud sewing or the like may be used for generating a target image. Furthermore, a target image may be generated by use of software for automatically or manually generating a high-texture image, such as software for making correction such that a captured image of a face is turned into an image of a beautiful face.

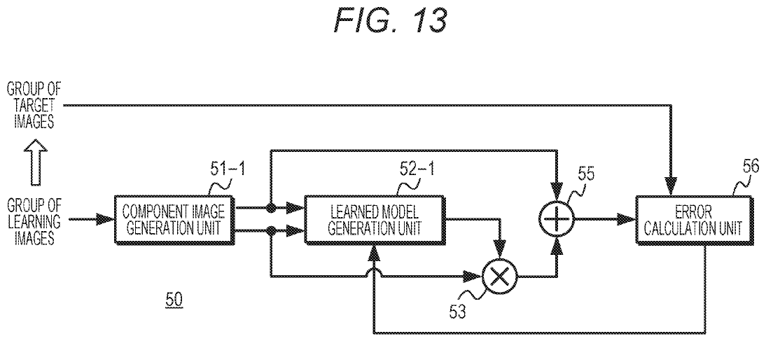

FIG. 13 shows a configuration of the learning apparatus that generates a learned model in the first embodiment. A learning apparatus 50 includes a component image generation unit 51-1, a learned model generation unit 52-1, a multiplication unit 53, an addition unit 55, and an error calculation unit 56. The component image generation unit 51-1 generates a diffuse reflection image and a specular reflection image of a learning image. The component image generation unit 51-1 includes, for example, the above-described polarization imaging unit 20, interpolation processing unit 31, and reflection component image generation unit 32, and generates a diffuse reflection image and a specular reflection image from a polarization image obtained as a result of imaging a subject for learning. The specular reflection image generated by the component image generation unit 51-1 is output to the learned model generation unit 52-1 and the multiplication unit 53. The diffuse reflection image is output to the learned model generation unit 52-1 and the addition unit 55.

The learned model generation unit 52-1 sets, for each pixel, gain for the specular reflection image on the basis of the specular reflection image and the diffuse reflection image by using a learning model, and outputs the gain to the multiplication unit 53. Furthermore, the learned model generation unit 52-1 adjusts parameters of a learning model, such as a parameter of a filter, in such a way as to reduce an error to be calculated by the error calculation unit 56 to be described later, and sets, as a learned model, a learning model that causes a smaller error such as a learning model that causes the smallest error. The learned model generation unit 52-1 uses, as a learning model, a deep learning model such as a convolutional neural network (CNN). Furthermore, assuming that an output image is less affected by an error observed in the gain set by use of the learned model, the learned model generation unit 52-1 may use a learning model in which the amount of calculation and the number of parameters are given priority over accuracy. For example, the learned model generation unit 52-1 may use a low-level structure of ResNet or a learning model such as GoogleNet or Enet.

The multiplication unit 53 multiplies the image signal of the specular reflection image by the gain set by the learned model generation unit 52-1 to perform level adjustment of the specular reflection image, and outputs the level-adjusted specular reflection image to the addition unit 55.

The addition unit 55 adds the specular reflection image and the level-adjusted specular reflection image supplied from the multiplication unit 53 to generate a comparison image. The addition unit 55 outputs the generated comparison image to the error calculation unit 56.

The error calculation unit 56 calculates an error of the comparison image with respect to a target image, and outputs the result of calculation to the learned model generation unit 52-1. For example, the error calculation unit 56 calculates, for a pixel i, a difference between a pixel signal xi of the comparison image and a pixel signal yi of the target image, as shown in equation (24), and outputs the result of addition of differences for all pixels N, as an error L of the comparison image with respect to the target image, to the learned model generation unit 52-1. Note that the error calculation unit 56 calculates the error of the comparison image with respect to the target image by using all the pixels, but may calculate the error of the comparison image with respect to the target image by using pixels in a desired subject region such as a face region.

$$[ Math . 2 ]$$

$$L = {\sum }_{i = 0}^{N} {( {y}_{i} - {x}_{i} )}^{2} \qquad ( 24 )$$

The learning apparatus 50 sets a learned model that reduces the error L calculated by the error calculation unit 56 such as a learned model that minimizes the error L, as a learned model to be used in the gain setting unit 331-1 of the target image generation unit 33-1.

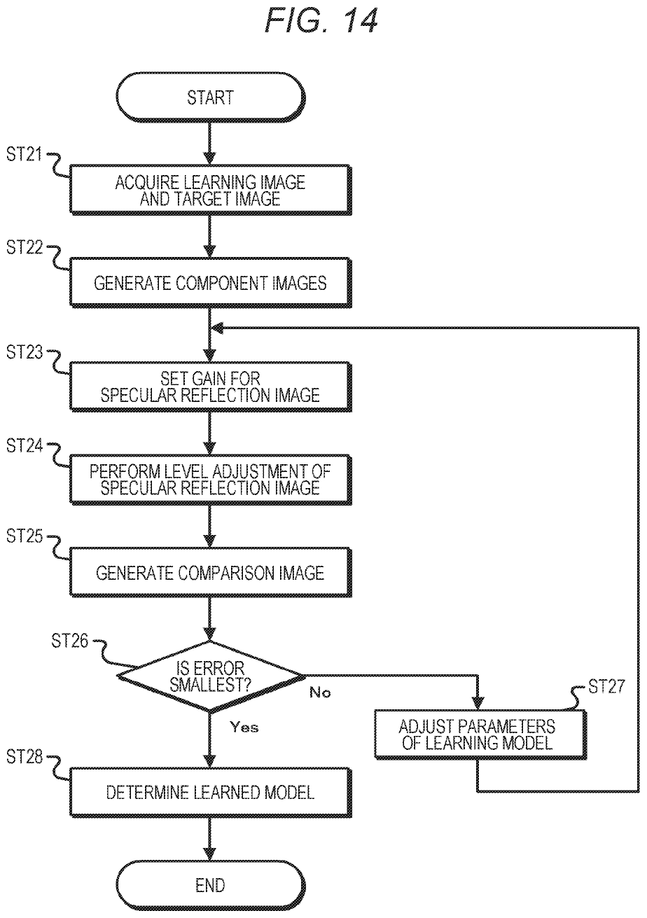

FIG. 14 is a flowchart showing the operation of the learning apparatus in the first embodiment. In step ST21, the learning apparatus acquires a learning image and a target image, and proceeds to step ST22.

In step ST22, the learning apparatus generates component images. The component image generation unit 51-1 of the learning apparatus 50 generates a specular reflection image and a specular reflection image of the learning image as component images, and proceeds to step ST23.

In step ST23, the learning apparatus sets gain for the specular reflection image. The learned model generation unit 52-1 of the learning apparatus 50 sets gain for each pixel of the specular reflection image by using a learning model on the basis of the specular reflection image and the diffuse reflection image, and proceeds to step ST24.

In step ST24, the learning apparatus performs level adjustment of the specular reflection image. The multiplication unit 53 of the learning apparatus 50 performs level adjustment of the specular reflection image with the gain set in step ST23, and proceeds to step ST25.

In step ST25, the learning apparatus generates a comparison image. The addition unit 55 of the learning apparatus 50 adds the diffuse reflection image generated in step ST22 and the specular reflection image subjected to the level adjustment in step ST24 to generate a comparison image, and proceeds to step ST26.

In step ST26, the learning apparatus determines whether an error between the comparison image and the target image is the smallest. The error calculation unit 56 of the learning apparatus 50 calculates an error between the target image acquired in step ST21 and the comparison image generated in step ST25. The learning apparatus 50 proceeds to step ST27 in a case where the error is not the smallest, and proceeds to step ST28 in a case where the error is the smallest. Note that whether or not the error is the smallest just needs to be determined on the basis of a change in the error observed when parameters of the learning model are adjusted.

In step ST27, the learning apparatus adjusts parameters of the learning model. The learned model generation unit 52-1 of the learning apparatus 50 changes parameters of the learning model, and returns to step ST23.

When the process proceeds from step ST26 to step ST28, the learning apparatus determines a learned model. The learned model generation unit 52-1 of the learning apparatus 50 sets a learning model that causes the smallest error as a learned model, and ends the process.

As described above, according to the first embodiment, it is possible to generate a high-texture image with no change in the original color of the subject, by adjusting the specular reflection component. In addition, in the case of learning non-linear processing for generating a target image from a learning image and performing learned spatial filter processing, there is a possibility of generating an unnatural image such as a face image that looks like an image of an artificial object depending on imaging conditions, a subject situation, and the like. In addition, the cost of learning non-linear processing increases. In contrast, in the first embodiment, the gain for a specular reflection component is adjusted to generate a target image. Thus, it is possible to obtain a robust processing result with respect to imaging conditions, a subject situation, and the like. Furthermore, learning cost can be reduced.

<2-2. Second Embodiment of Target Image Generation Unit>

Next, in a second embodiment of the target image generation unit, not only a specular reflection component but also a diffuse reflection component is adjusted.

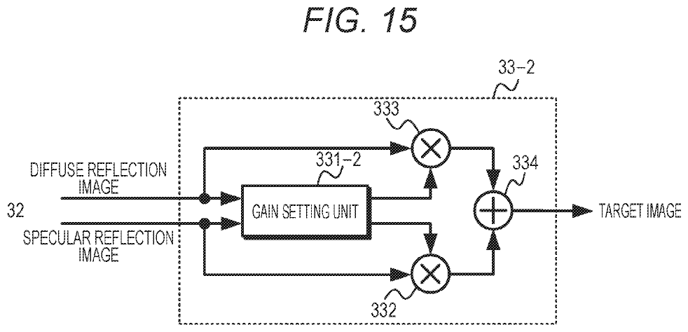

FIG. 15 shows a configuration of a target image generation unit in the second embodiment. A target image generation unit 33-2 includes a gain setting unit 331-2, multiplication units 332 and 333, and an addition unit 334.

A specular reflection image representing a specular reflection component Rs calculated by a reflection component image generation unit 32 is output to the gain setting unit 331 and the multiplication unit 332. A diffuse reflection image representing a diffuse reflection component Rd is output to the gain setting unit 331-2 and the multiplication unit 333.

The gain setting unit 331-2 sets, for each pixel, gain for the specular reflection image and gain for the diffuse specular reflection image on the basis of the specular reflection image and the diffuse reflection image by using a learned model. The gain setting unit 331-2 outputs the gain for the specular reflection image to the multiplication unit 332, and outputs the gain for the diffuse reflection image to the multiplication unit 333. Note that details of the learned model will be described later.

The multiplication unit 332 multiplies the image signal of the specular reflection image by the gain set by the gain setting unit 331-2 to perform level adjustment of the specular reflection image, and outputs the level-adjusted specular reflection image to the addition unit 334.

The multiplication unit 333 multiplies the image signal of the diffuse reflection image by the gain set by the gain setting unit 331-2 to perform level adjustment of the diffuse reflection image, and outputs the level-adjusted diffuse reflection image to the addition unit 334.

The addition unit 334 adds the level-adjusted specular reflection image supplied from the multiplication unit 332 and the level-adjusted diffuse reflection image supplied from the multiplication unit 333 to generate a high-texture image.

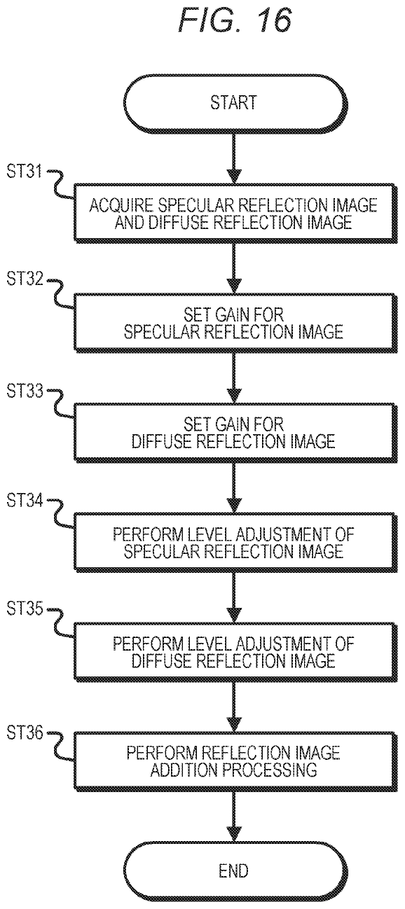

FIG. 16 is a flowchart showing the operation of the target image generation unit in the second embodiment. In step ST31, the target image generation unit acquires a specular reflection image and a diffuse reflection image. The target image generation unit 33-2 acquires a specular reflection image representing a specular reflection component calculated by the component image generation unit 32 and a specular reflection image representing a diffuse reflection component, and proceeds to step ST32.

In step ST32, the target image generation unit sets gain for the specular reflection image. The target image generation unit 33-2 sets gain for each pixel of the specular reflection image by using a preset learned model on the basis of the specular reflection image and the diffuse reflection image, and proceeds to step ST33.

In step ST33, the target image generation unit sets gain for the diffuse reflection image. The target image generation unit 33-2 sets gain for each pixel of the diffuse reflection image by using the preset learned model on the basis of the specular reflection image and the diffuse reflection image, and proceeds to step ST34.

In step ST34, the target image generation unit performs level adjustment of the specular reflection image. The target image generation unit 33-2 performs level adjustment of the specular reflection image with the gain set in step ST32, and proceeds to step ST35.

In step ST35, the target image generation unit performs level adjustment of the diffuse reflection image. The target image generation unit 33-2 performs level adjustment of the diffuse reflection image with the gain set in step ST33, and proceeds to step ST36.

In step ST36, the target image generation unit performs reflection image addition processing. The target image generation unit 33-2 adds the specular reflection image subjected to the level adjustment in step ST34 and the diffuse reflection image subjected to the level adjustment in step ST35 to generate a target image.

Note that, in FIG. 16, the processing of steps ST32 and ST33 may be performed in reverse order. Alternatively, the processing of steps ST33 and ST34 may be performed in reverse order. Furthermore, the processing of steps ST34 and ST35 may be performed in reverse order or in parallel.

Next, a learning apparatus that generates a learned model will be described. As in the first embodiment, a learning apparatus 50 performs machine learning by using a group of learning images acquired by use of a polarization imaging unit 20 and a desired target image corresponding to each image of the group of learning images, and generates a learned model.

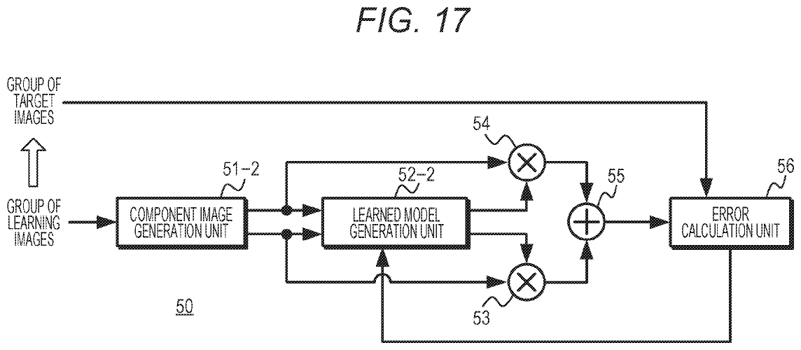

FIG. 17 shows a configuration of the learning apparatus that generates a learned model in the second embodiment. The learning apparatus 50 includes a component image generation unit 51-2, a learned model generation unit 52-2, multiplication units 53 and 54, an addition unit 55, and an error calculation unit 56. As with the component image generation unit 51-1, the component image generation unit 51-2 generates a diffuse reflection image and a specular reflection image of a learning image. The specular reflection image generated by the component image generation unit 51-2 is output to the learned model generation unit 52-2 and the multiplication unit 53. The diffuse reflection image is output to the learned model generation unit 52-2 and the multiplication unit 54.

The learned model generation unit 52-2 sets, for each pixel, gain for the specular reflection image and gain for the diffuse reflection image on the basis of the specular reflection image and the diffuse reflection image by using a learning model. The learned model generation unit 52-2 outputs the gain for the specular reflection image to the multiplication unit 53, and outputs the gain for the diffuse reflection image to the multiplication unit 54. Furthermore, the learned model generation unit 52-2 adjusts parameters of the learning model in such a way as to reduce an error to be calculated by the error calculation unit 56 to be described later, and sets a learning model that causes a smaller error, as a learned model. Note that as with the learned model generation unit 52-1, the learned model generation unit 52-2 uses, as a learning model, a deep learning model such as a convolutional neural network (CNN).

The multiplication unit 53 multiplies the image signal of the specular reflection image by the gain set by the learned model generation unit 52-2 to perform level adjustment of the specular reflection image, and outputs the level-adjusted specular reflection image to the addition unit 55.

The multiplication unit 54 multiplies the image signal of the diffuse reflection image by the gain set by the learned model generation unit 52-2 to perform level adjustment of the diffuse reflection image, and outputs the level-adjusted specular reflection image to the addition unit 55.

The addition unit 55 adds the level-adjusted specular reflection image supplied from the multiplication unit 53 and the level-adjusted diffuse reflection image supplied from the multiplication unit 54 to generate a comparison image. The addition unit 55 outputs the generated comparison image to the error calculation unit 56.

The error calculation unit 56 calculates an error of the comparison image with respect to a target image, and outputs the result of calculation to the learned model generation unit 52-2.

The learning apparatus 50 sets a learned model that reduces an error L calculated by the error calculation unit 56, such as a learned model that minimizes the error L, as a learned model to be used in the target image generation unit 33-2.

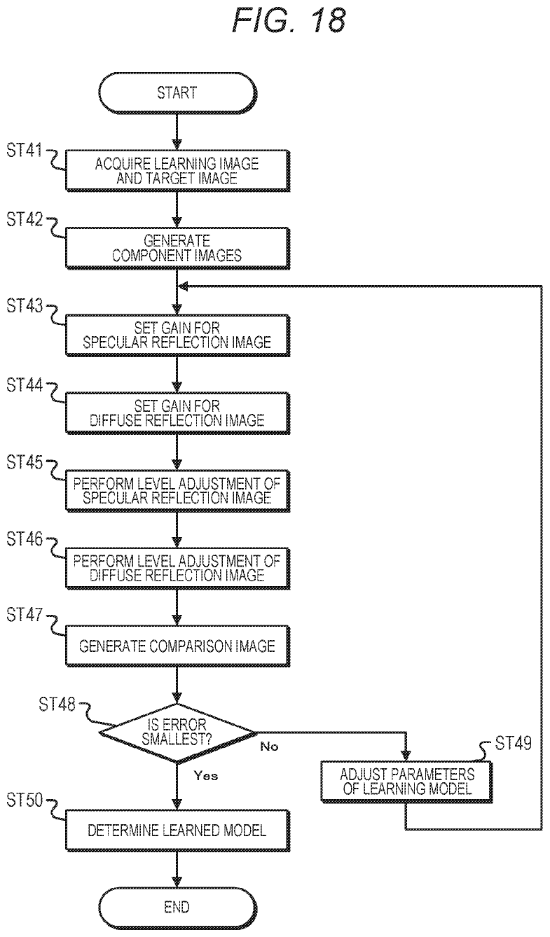

FIG. 18 is a flowchart showing the operation of the learning apparatus in the second embodiment. In step ST41, the learning apparatus acquires a learning image and a target image, and proceeds to step ST42.

In step ST42, the learning apparatus generates component images. The component image generation unit 51-2 of the learning apparatus 50 generates a specular reflection image and a specular reflection image of the learning image as component images, and proceeds to step ST43.

In step ST43, the learning apparatus sets gain for the specular reflection image. The learned model generation unit 52-2 of the learning apparatus 50 sets gain for each pixel of the specular reflection image by using a learning model on the basis of the specular reflection image and the diffuse reflection image, and proceeds to step ST44.

In step ST44, the learning apparatus sets gain for the diffuse reflection image. The learned model generation unit 52-2 of the learning apparatus 50 sets gain for each pixel of the diffuse reflection image by using the learning model on the basis of the specular reflection image and the diffuse reflection image, and proceeds to step ST45.

In step ST45, the learning apparatus performs level adjustment of the specular reflection image. The multiplication unit 53 of the learning apparatus 50 performs level adjustment of the specular reflection image with the gain set in step ST43, and proceeds to step ST46.

In step ST46, the learning apparatus performs level adjustment of the diffuse reflection image. The multiplication unit 54 of the learning apparatus 50 performs level adjustment of the diffuse reflection image with the gain set in step ST44, and proceeds to step ST47.

In step ST47, the learning apparatus generates a comparison image. The addition unit 53 of the learning apparatus 50 adds the specular reflection image subjected to the level adjustment in step ST45 and the diffuse reflection image subjected to the level adjustment in step ST45 to generate a comparison image, and proceeds to step ST48.

In step ST48, the learning apparatus determines whether an error between the comparison image and the target image is the smallest. The error calculation unit 56 of the learning apparatus 50 calculates an error between the target image acquired in step ST41 and the comparison image generated in step ST47. The learning apparatus 50 proceeds to step ST49 in a case where the error is not the smallest, and proceeds to step ST50 in a case where the error is the smallest.

In step ST49, the learning apparatus adjusts parameters of the learning model. The learned model generation unit 52-2 of the learning apparatus 50 changes parameters of the learning model, and returns to step ST43.

When the process proceeds from step ST48 to step ST50, the learning apparatus determines a learned model. The learned model generation unit 52-2 of the learning apparatus 50 sets a learning model that causes the smallest error as a learned model, and ends the process.

As described above, according to the second embodiment, it is possible to generate a high-texture output image by adjusting the specular reflection component and the diffuse reflection component. Therefore, it is possible to obtain similar effects as those in the first embodiment. Furthermore, the diffuse reflection component can also be adjusted in the second embodiment. Therefore, it is possible to perform processing with a higher degree of freedom than in the first embodiment.

<2-3. Third Embodiment of Target Image Generation Unit>

Next, a third embodiment of the target image generation unit will be described. In the above-described first and second embodiments, there are used a specular reflection image and a diffuse reflection image that are images including no phase information regarding polarization. Therefore, in the third embodiment, a polarization image for each polarization component is used as a component image so that it is possible to generate a target image including phase information regarding polarization. Note that in the following description, a polarization image representing a polarization component in a polarization direction of 0° will be referred to as a 0° polarization component image. Furthermore, a polarization image representing a polarization component in a polarization direction of 45° will be referred to as a 45° polarization component image, a polarization image representing a polarization component in a polarization direction of 90° will be referred to as a 90° polarization component image, and a polarization image representing a polarization component in a polarization direction of 135° will be referred to as a 135° polarization component image.

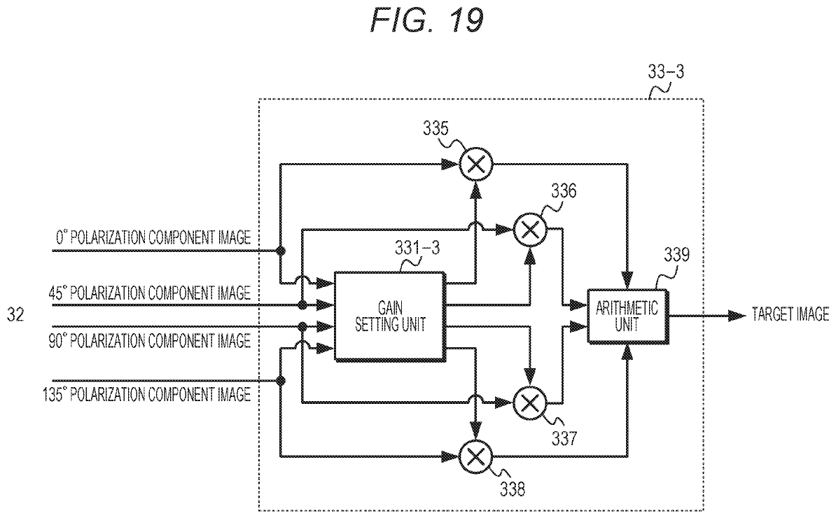

FIG. 19 shows a configuration of a target image generation unit in the third embodiment. A target image generation unit 33-3 includes a gain setting unit 331-3, multiplication units 335 to 338, and an arithmetic unit 339.

A 0° polarization component image generated by an interpolation processing unit 31 is output to the gain setting unit 331-3 and the multiplication unit 335. Furthermore, a 45° polarization component image is output to the gain setting unit 331-3 and the multiplication unit 336. A 90° polarization component image is output to the gain setting unit 331-3 and the multiplication unit 337. A 135° polarization component image is output to the gain setting unit 331-3 and the multiplication unit 338.

The gain setting unit 331-3 uses a learned model to set, for each pixel, gain for the 0° polarization component image, the 45° polarization component image, the 90° polarization component image, and the 135° polarization component image on the basis of the 0° polarization component image, the 45° polarization component image, the 90° polarization component image, and the 135° polarization component image. The gain setting unit 331-3 outputs the gain for the 0° polarization component image to the multiplication unit 335. Furthermore, the gain setting unit 331-3 outputs the gain for the 45° polarization component image to the multiplication unit 336, outputs the gain for the 90° polarization component image to the multiplication unit 337, and outputs the gain for the 135° polarization component image to the multiplication unit 338.

The multiplication unit 335 multiplies the image signal of the 0° polarization component image by the gain set by the gain setting unit 331-3 to perform level adjustment of the 0° polarization component image, and outputs the level-adjusted 0° polarization component image to the arithmetic unit 339.

The multiplication unit 336 multiplies the image signal of the 45° polarization component image by the gain set by the gain setting unit 331-3 to perform level adjustment of the 45° polarization component image, and outputs the level-adjusted 45° polarization component image to the arithmetic unit 339.

The multiplication unit 337 multiplies the image signal of the 90° polarization component image by the gain set by the gain setting unit 331-3 to perform level adjustment of the 90° polarization component image, and outputs the level-adjusted 90° polarization component image to the arithmetic unit 339.

The multiplication unit 335 multiplies the image signal of the 135° polarization component image by the gain set by the gain setting unit 331-3 to perform level adjustment of the 135° polarization component image, and outputs the level-adjusted 135° polarization component image to the arithmetic unit 339.

The arithmetic unit 339 calculates an average value for each pixel by using the pixel signals of the level-adjusted polarization component images supplied from the multiplication units 335 to 338 to obtain a pixel signal of a high-texture image.

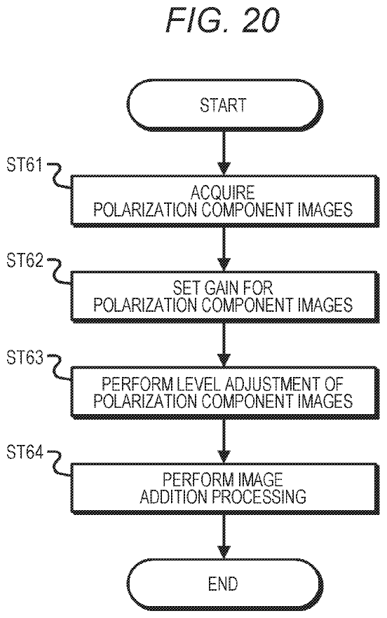

FIG. 20 is a flowchart showing the operation of the target image generation unit in the third embodiment. In step ST61, the target image generation unit acquires polarization component images. The target image generation unit 33-3 acquires a polarization component image generated by the interpolation processing unit 31 for each polarization direction and each color component, and proceeds to step ST62.

In step ST62, the target image generation unit sets gain for the polarization component images. The target image generation unit 33-3 sets gain for each polarization direction and each pixel by using a preset learned model on the basis of the polarization component images, and proceeds to step ST63.

In step ST63, the target image generation unit performs level adjustment of the polarization component images. The target image generation unit 33-3 performs level adjustment of each polarization component image with the gain set in step ST62, and proceeds to step ST64.

In step ST64, the target image generation unit performs image addition processing. The target image generation unit 33-3 adds the polarization component images subjected to the level adjustment in step ST63 to generate a target image.

Next, a learning apparatus that generates a learned model will be described. As in the first and second embodiments, a learning apparatus 50 performs machine learning by using a group of learning images acquired by use of a polarization imaging unit 20 and a desired target image corresponding to each image of the group of learning images, and generates a learned model.

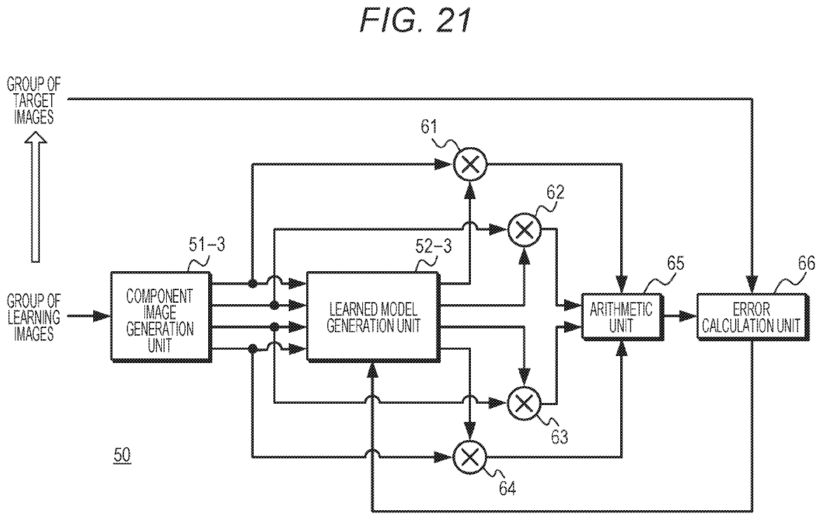

FIG. 21 shows a configuration of the learning apparatus that generates a learned model in the third embodiment. The learning apparatus 50 includes a component image generation unit 51-3, a learned model generation unit 52-3, multiplication units 61 to 64, an arithmetic unit 65, and an error calculation unit 66. The component image generation unit 51-3 generates a 0° polarization component image, a 45° polarization component image, a 90° polarization component image, and a 135° polarization component image of a learning image. The 0° polarization component image generated by the component image generation unit 51-3 is output to the learned model generation unit 52-3 and the multiplication unit 61. Furthermore, the 45° polarization component image is output to the learned model generation unit 52-3 and the multiplication 62, the 90° polarization component image is output to the learned model generation unit 52-3 and the multiplication unit 63, and the 135° polarization component image is output to the learned model generation unit 52-3 and the multiplication unit 64.

The learned model generation unit 52-3 uses a learning model to set, for each pixel, gain for each polarization component image on the basis of the 0° polarization component image, the 45° polarization component image, the 90° polarization component image, and the 135° polarization component image. The learned model generation unit 52-3 outputs the gain for the 0° polarization component image to the multiplication unit 61. Furthermore, the learned model generation unit 52-3 outputs the gain for the 45° polarization component image to the multiplication 62, outputs the gain for the 90° polarization component image to the multiplication unit 63, and outputs the gain for the 135° polarization component image to the multiplication unit 64. In addition, the learned model generation unit 52-3 adjusts parameters of the learning model in such a way as to reduce an error to be calculated by the error calculation unit 66 to be described later, and sets a learning model that causes a smaller error, as a learned model. Note that as with the learned model generation units 52-1 and 52-2, the learned model generation unit 52-2 uses, as a learning model, a deep learning model such as a convolutional neural network (CNN).

The multiplication unit 61 multiplies the image signal of the 0° polarization component image by the gain set by the learned model generation unit 52-3 to perform level adjustment of the 0° polarization component image, and outputs the level-adjusted 0° polarization component to the arithmetic unit 65.

The multiplication unit 62 multiplies the image signal of the 45° polarization component image by the gain set by the learned model generation unit 52-3 to perform level adjustment of the 45° polarization component image, and outputs the level-adjusted 45° polarization component image to the arithmetic unit 65.

The multiplication unit 63 multiplies the image signal of the 90° polarization component image by the gain set by the learned model generation unit 52-3 to perform level adjustment of the 90° polarization component image, and outputs the level-adjusted 90° polarization component to the arithmetic unit 65.

The multiplication unit 64 multiplies the image signal of the 135° polarization component image by the gain set by the learned model generation unit 52-3 to perform level adjustment of the 135° polarization component image, and outputs the level-adjusted 135° polarization component image to the arithmetic unit 65.

The arithmetic unit 65 calculates an average value for each pixel position by using the pixel signals of the level-adjusted 0° polarization component image supplied from the multiplication unit 61, the level-adjusted 45° polarization component image supplied from the multiplication unit 62, the level-adjusted 90° polarization component image supplied from the multiplication unit 63, and the level-adjusted 135° polarization component image supplied from the multiplication unit 64. Moreover, the arithmetic unit 65 generates a comparison image with the average values as pixel signals. The arithmetic unit 65 outputs the generated comparison image to the error calculation unit 66.

The error calculation unit 66 calculates an error of the comparison image with respect to a target image, and outputs the result of calculation to the learned model generation unit 52-3.

The learning apparatus 50 sets a learned model that reduces an error L calculated by the error calculation unit 66, such as a learned model that minimizes the error L, as a learned model to be used in the target image generation unit 33-3.

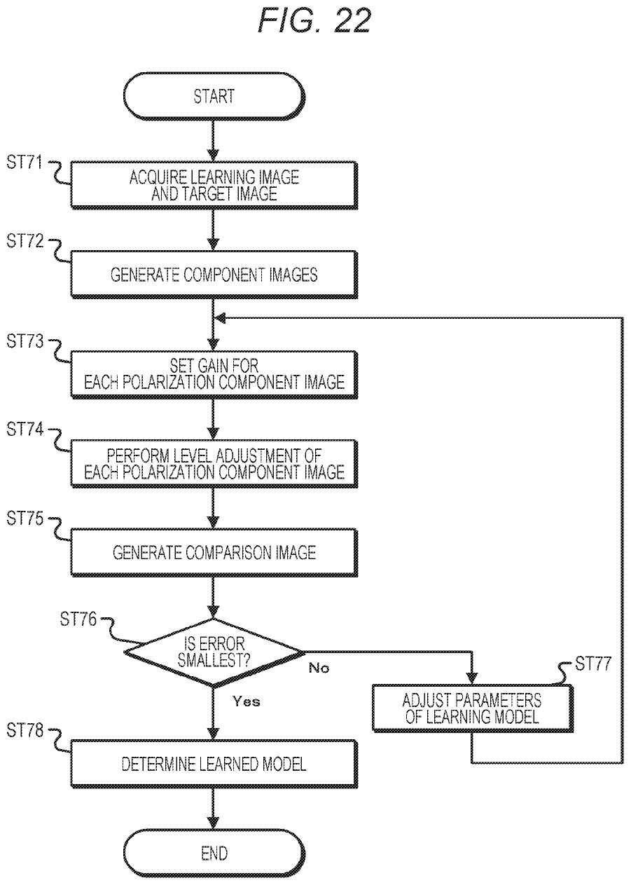

FIG. 22 is a flowchart showing the operation of the learning apparatus in the third embodiment. In step ST71, the learning apparatus acquires a learning image and a target image, and proceeds to step ST72.

In step ST72, the learning apparatus generates component images. The component image generation unit 51-3 of the learning apparatus 50 generates, as a component image, a polarization component image for each polarization direction of the learning image, and proceeds to step ST73.

In step ST73, the learning apparatus sets gain for each polarization component image. The learned model generation unit 52-3 of the learning apparatus 50 sets gain for each pixel of each polarization component image by using a learning model on the basis of each polarization component image, and proceeds to step ST74.

In step ST74, the learning apparatus performs level adjustment of each polarization component image. The multiplication units 61 to 64 of the learning apparatus 50 perform level adjustment of respective polarization component images with the gain set in step ST73. For example, the multiplication unit 61 performs level adjustment of a polarization component image in a first polarization direction. Furthermore, the multiplication units 61 to 64 perform level adjustment of polarization component images in second to fourth polarization directions, respectively, and proceed to step ST75.

In step ST75, the learning apparatus generates a comparison image. The arithmetic unit 65 of the learning apparatus 50 averages the polarization component images subjected to the level adjustment in step ST74 to generate a comparison image, and proceeds to step ST76.

In step ST76, the learning apparatus determines whether an error between the comparison image and the target image is the smallest. The error calculation unit 66 of the learning apparatus 50 calculates an error between the target image acquired in step ST71 and the comparison image generated in step ST75. The learning apparatus 50 proceeds to step ST77 in a case where the error is not the smallest, and proceeds to step ST78 in a case where the error is the smallest.

In step ST77, the learning apparatus adjusts parameters of the learning model. The learned model generation unit 52-3 of the learning apparatus 50 changes parameters of the learning model, and returns to step ST73.

When the process proceeds from step ST76 to step ST78, the learning apparatus determines a learned model. The learned model generation unit 52-3 of the learning apparatus 50 sets a learning model that causes the smallest error as a learned model, and ends the process.

As described above, according to the third embodiment, it is possible to generate a high-texture output image by adjusting the 0° polarization component, the 45° polarization component, the 90° polarization component, and the 135° polarization component and adding the polarization components. Therefore, although the cost is higher than in the first and second embodiments in which no polarization phase information is used, accuracy can be improved.

<2-4. Fourth Embodiment of Target Image Generation Unit>

Incidentally, in the third embodiment, gain is set for each polarization component image by using polarization component images of four polarization directions, and an output image is generated from each of the polarization component images subjected to level adjustment by use of the set gain. However, polarization component images to be used are not limited to the polarization component images of four polarization directions, and a learned model or an output image may be generated by use of polarization component images of three polarization directions, polarization component images of two polarization directions, or a polarization component image of a single polarization direction. Note that although the amount of information decreases as the number of polarization component images decreases, it is possible to reduce the cost required for generating a learned model and generating a target image. In addition, sensitivity can be increased. This is because the number of unpolarized pixels increases as the number of polarized pixels to be provided in a block of a predetermined size, such as 4×4 pixels, is reduced in the image sensor.

### 3. Another Embodiment

Cases where a high-texture face image is generated from a polarization image obtained as a result of imaging a human face have been described in the first to fourth embodiments. However, a subject is not limited to a person, and another subject may be imaged. In this case, a learned model just needs to be generated according to the another subject. For example, in the case of generating a high-texture scenery image, a learned model just needs to be generated by use of a group of learning images representing scenery and a group of target images. In the case of generating a high-texture food image, a learned model just needs to be generated by use of a group of learning images representing food and a group of target images. In addition, a target image is not limited to a high-texture image, and if a learned model is generated by use of an image with desired characteristics, an image with the desired characteristics can be generated from a polarization image.

Furthermore, if polarized illumination light (light obtained as a result of outputting unpolarized light emitted from a light source through a polarizer) is used as illumination light, specularly reflected light remains polarized, and diffusely reflected light turns to unpolarized light. Therefore, it becomes easy to generate a specular reflection image and a diffuse reflection image. In addition, illumination light may be sunlight or the like. In this case, reflection from the surface of a leaf can be separated as a specular reflection component.

Furthermore, the polarization imaging unit 20 and the image processing unit 30 may be provided integrally or separately. Furthermore, the image processing unit 30 may generate a target image not only by using a polarization image acquired by the polarization imaging unit 20 to perform the above-described processing online, but also by using a polarization image recorded on a recording medium or the like to perform the above-described processing offline.

### 4. Application Examples

The technology according to the present disclosure can be applied to various fields. For example, the technology according to the present disclosure may be implemented as an apparatus to be mounted on any type of mobile object such as an automobile, an electric vehicle, a hybrid electric vehicle, a motorcycle, a bicycle, a personal mobility vehicle, an airplane, a drone, a ship, or a robot. Furthermore, the technology according to the present disclosure may be implemented as an apparatus to be mounted on a device to be used in a production process in a factory or a device to be used in the construction field. When the technology according to the present disclosure is applied to such fields, it is possible to correct a polarization state change in polarization state information caused by a lens. Therefore, it is possible to, for example, accurately generate normal line information and separate reflection components on the basis of the corrected polarization state information. Therefore, the surrounding environment can be three-dimensionally grasped with accuracy, so that driver fatigue or worker fatigue can be reduced. In addition, it becomes possible to perform automatic driving and the like more safely.

The technology according to the present disclosure can also be applied to the medical field. For example, if the technology according to the present disclosure is applied to the case of using a captured image of a surgical site when performing surgery, it becomes possible to accurately obtain an image showing a three-dimensional shape of the surgical site with no reflection. It is thus possible to reduce operator fatigue and perform surgery safely and more reliably.

Furthermore, the technology according to the present disclosure can also be applied to the field of public services or the like. For example, when an image of a subject is published in a book, a magazine, or the like, it is possible to accurately remove unnecessary reflection components and the like from the image of the subject.

Furthermore, a series of processes described in the specification can be implemented by hardware, software, or a configuration in which hardware and software are combined. In a case where the processes are implemented by software, a program in which a process sequence has been recorded is executed after being installed in a memory in a computer incorporated in dedicated hardware. Alternatively, the program can be executed after being installed on a general-purpose computer capable of performing various types of processing.

For example, the program can be recorded in a hard disk, a solid state drive (SSD), or a read only memory (ROM) as a recording medium in advance. Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray Disc (BD) (registered trademark), a magnetic disk, or a semiconductor memory card. Such a removable recording medium can be provided as so-called package software.

Furthermore, the program may be installed on a computer from a removable recording medium, or may also be transferred through wireless or wired communication from a download site to the computer via a network such as a local area network (LAN) or the Internet. The computer can receive the program transferred in this way and install the program on a recording medium such as a built-in hard disk.

Note that the effects described in the present specification are merely illustrative and not restrictive, and additional effects not described herein may also be achieved. Furthermore, the present technology should not be construed as being limited to the embodiments of the technology described above. The embodiments of the present technology disclose the present technology in the form of illustration, and it is obvious that those skilled in the art can make modifications or substitutions of the embodiments without departing from the gist of the present technology. That is, in order to judge the gist of the present technology, the claims should be taken into consideration.

Furthermore, the image processing apparatus of the present technology can also adopt the following configurations.

(1) An image processing apparatus including:

a target image generation unit that performs level adjustment of a component image obtained from a polarization image with gain set by use of a learned model on the basis of the component image, and generates a target image from the level-adjusted component image.

(2) The image processing apparatus according to (1), in which

the learned model is a learning model that is used to set gain with which level adjustment of a component image obtained from a learning image is performed on the basis of the component image, the learning model reducing a difference between an evaluation image generated by use of the level-adjusted component image and a target image for the learning image.

(3) The image processing apparatus according to (2), in which

the learning model is a deep learning model.

(4) The image processing apparatus according to any one of (1) to (3), in which

the component images include a specular reflection image and a diffuse reflection image, and

the target image generation unit sets gain for the specular reflection image or gain for the specular reflection image and the diffuse reflection image by using a learned model.

(5) The image processing apparatus according to (4), in which

the target image generation unit generates the target image on the basis of the diffuse reflection image and the level-adjusted specular reflection image.

(6) The image processing apparatus according to (4), in which

the target image generation unit generates the target image on the basis of the level-adjusted specular reflection image and the level-adjusted diffuse reflection image.

(7) The image processing apparatus according to any one of (1) to (3), in which

the component image is a polarization component image for each polarization direction, and

the target image generation unit sets gain for the polarization component image for each polarization direction by using a learned model, and generates the target image on the basis of the level-adjusted polarization component images.

(8) The image processing apparatus according to any one of (1) to (7), in which

the target image generation unit performs level adjustment of the component image with gain set for each pixel by using a learned model on the basis of the component image.

(9) The image processing apparatus according to any one of (1) to (8), further including:

a polarization imaging unit that acquires the polarization image.

(10) The image processing apparatus according to any one of (1) to (9), in which

the polarization image is an image acquired as a result of performing imaging by using polarized illumination light.

### INDUSTRIAL APPLICABILITY

In the image processing apparatus, the image processing method, and the program of the present technology, level adjustment of a component image obtained from a polarization image is performed with gain set by use of a learned model on the basis of the component image, and a target image is generated from the level-adjusted component image. Furthermore, the learning apparatus generates a learned model. Thus, it is possible to easily obtain a target image from a polarization image. Therefore, the present technology is suitable to, for example, the field of public services or the like where a high-texture image is required, a mobile object or various devices using polarization information and a high-texture image, and the medical field.

### REFERENCE SIGNS LIST

10 Imaging system
20 Polarization imaging unit
30 Image processing unit
31 Interpolation processing unit
32 Component image generation unit
33, 33-1, 33-2, 33-3 Target image generation unit
50 Learning apparatus
51-1, 51-2, 51-3 Component image generation unit
52-1, 52-2, 52-3 Learned model generation unit
53, 54, 61 to 64, 332, 333, 335 to 338 Multiplication unit
55, 334 Addition unit
56, 66 Error calculation unit
65, 339 Arithmetic unit
201 Image sensor
202 Polarization filter
203 Lens
204, 211, 2121 to 2124 Polarizing plate
210, 210-1 to 210-4 Imaging unit
311 Low-frequency component calculation unit
312 Component information acquisition unit
313 Signal calculation unit
331-1, 331-2, 331-3 Gain setting unit

1. An image processing apparatus comprising:
a target image generation unit that performs level adjustment of a component image obtained from a polarization image with gain set by use of a learned model on a basis of the component image, and generates a target image from the level-adjusted component image.

2. The image processing apparatus according to claim 1, wherein
the learned model is a learning model that is used to set gain with which level adjustment of a component image obtained from a learning image is performed on a basis of the component image, the learning model reducing a difference between an evaluation image generated by use of the level-adjusted component image and a target image for the learning image.

3. The image processing apparatus according to claim 2, wherein
the learning model is a deep learning model.

4. The image processing apparatus according to claim 1, wherein
the component images include a specular reflection image and a diffuse reflection image, and
the target image generation unit sets gain for the specular reflection image or gain for the specular reflection image and the diffuse reflection image by using a learned model.

5. The image processing apparatus according to claim 4, wherein
the target image generation unit generates the target image on a basis of the diffuse reflection image and the level-adjusted specular reflection image.

6. The image processing apparatus according to claim 4, wherein
the target image generation unit generates the target image on a basis of the level-adjusted specular reflection image and the level-adjusted diffuse reflection image.

7. The image processing apparatus according to claim 1, wherein
the component image is a polarization component image for each polarization direction, and
the target image generation unit sets gain for the polarization component image for each polarization direction by using a learned model, and generates the target image on a basis of the level-adjusted polarization component images.

8. The image processing apparatus according to claim 1, wherein
the target image generation unit performs level adjustment of the component image with gain set for each pixel by using a learned model on a basis of the component image.

9. The image processing apparatus according to claim 1, further comprising:
a polarization imaging unit that acquires the polarization image.

10. The image processing apparatus according to claim 1, wherein
the polarization image is an image acquired as a result of performing imaging by using polarized illumination light.

11. An image processing method comprising:
causing a target image generation unit to perform level adjustment of a component image obtained from a polarization image with gain set by use of a learned model on a basis of the component image, and generate a target image from the level-adjusted component image.

12. A program for causing a computer to perform image processing by using a polarization image, the program causing the computer to perform:
a step of setting gain by using a learned model on a basis of a component image obtained from a polarization image;
a step of performing level adjustment of the component image with the set gain; and
a step of generating a target image from the level-adjusted component image.

13. A learning apparatus comprising:
a learned model generation unit that performs level adjustment of a component image obtained from a learning image with gain set by use of a learning model on a basis of the component image, and sets, as a learned model, the learning model that reduces a difference between an evaluation image generated by use of the level-adjusted component image, and a target image.

14. The learning apparatus according to claim 13, wherein
the learning model is a deep learning model.
